(19) United States
(12) Patent Application Publication
(10) Pub. No.: US 2011/0162226 A1
(43) Pub. Date: Jul. 7, 2011

(54) ILLUMINATION CHAMBER FOR HARDENING RADIATION-CUREABLE COATINGS

(75) Inventor: Claudia Witt, Eberdingen (DE)

(73) Assignee: DAIMLER AG, Stuttgart (DE)

(21) Appl. No.: 13/062,990

(22) PCT Filed: Aug. 25, 2009
(86) PCT No.: PCT/EP2009/006146

§ 371 Date: Mar. 9, 2011

(30) Foreign Application Priority Data
Sep. 10, 2008 (DE) 10 2008 046 548.8

(51) Int. Cl. F26B 3/34

(52) U.S. Cl. 34/276; 34/275

(57) ABSTRACT

The invention relates to an exposure chamber (10) for hardening radiation-curable coatings on components (14) having surfaces which are oriented in different directions. The invention also relates to an exposure chamber (10) for hardening motor vehicle bodies coated with UV-paints by means of UV-lamps. According to the invention, at least one reflector (20) is arranged in an inner chamber (18) of the exposure chamber (10). Said type of reflector (20) is preferably spherical or alternatively can be pivoted about three spatial axes in a cardanic manner such that, owing to this reflector (20), shadow zones of the vehicle body which are normally exposed inadequately can be uniformly illuminated. The invention further relates to a hardening system (42, 42′) for motor vehicle bodies which comprises said type of exposure chamber.

The invention relates to an exposure system, in particular an exposure chamber, for hardening light-curable coatings on components, in particular body paint on vehicle bodies, with the features of claim 1.

Light- or UV-curable coatings (so-called UV-paints) require irradiation with high-energy radiation for hardening. In this context, it is important that the (UV) light should be applied to all regions of the painted surface with a high radiant energy density as evenly as possible.

In a frequently used concept, high-energy emitters are placed as close as possible to the surface and guided across the surface. From WO 2006030101 for example, a system for exposing vehicle bodies is known, wherein the UV-emitter is guided past the body. DE 102 24 514 A1 discloses the matching of the UV-emitters to the contour of the component to be irradiated to improve the UV-cure of a surface paint.

A further concept provides exposure chambers. An exposure chamber is known from DE 10 2004 057 139 A1. It comprises a plurality of UV-emitters which allow the component the surface of which is to be exposed to be exposed to ultraviolet radiation. Several UV-lamps, in particular high-power emitters, are provided in a hardening chamber.

Depending on the shape of the component to be irradiated, there may however be shadow zones in such exposure chambers, resulting in an undesirably weak irradiation of shaded component regions. In order to ensure that these regions too are reliably cured, exposure times usually have to be extended, or the lamps have to be moved relative to the component, which has a disadvantageous effect on cycle times and moreover increases energy consumption and thus costs.

The invention is therefore based on the problem of providing an exposure chamber for vehicle bodies for hardening radiation-curable paints, which minimises the effect of shadow zones at a component to be irradiated on the hardening of the coating and thus improves the process in terms of process technology and economy.

This problem is solved by an exposure chamber with the features of patent claim 1 and by a hardening system for vehicle bodies with the features of patent claim 21.

The exposure chamber according to the invention for hardening radiation-curable coatings on components with variously oriented surfaces by means of UV-lamps is characterized in that at least one reflector is provided in an interior of the exposure chamber. By providing one or more of such reflectors, light can be distributed more evenly in the interior of the exposure chamber, so that the effect of component geometry-related shadow zones on the component can be reduced. As a result, exposure times and therefore cycle times can be reduced, and costs can be reduced by lower power consumption.

The at least one reflector can preferably be arranged such that the UV-radiation emitted by the UV-lamps is directly reflected into a shadow zone of a component by the reflector.

In the interior of the exposure chamber, at least one reflector for UV-rays is therefore arranged such that the UV-radiation coming from the wall region of the exposure chamber or from outside is reflected by the reflector into a shadow zone of a component which cannot be reached directly by the UV-rays from the wall. While the UV-emitters are placed directly on or in the wall, the reflector is located in the interior of the exposure chamber and close to the component or alternatively in an interior of an at least partially hollow component, such as a motor vehicle body.

The component to be exposed is a three-dimensional body with an irregular outer contour and/or openings or cavities.

The number and the arrangement of such reflectors are preferably varied to match the component to be exposed, permitting their adaptation to the respective component geometry. Depending on component geometry, the reflector(s) may be located outside or within the component. In the case of vehicle bodies, for example, it is expedient to provide at least one reflector in the interior of the body. The UV-radiation reaches the interior of the body via the window openings or open doors or tailgates. The radiation is in particular reflected onto the interior regions of the doors and tailgates.

In a preferred embodiment of the invention, the at least one reflector comprises a spherical base body. This may be directly silvered, for example by vapour-coating with a reflective material, resulting in a uniform reflection of the radiated UV-light in all spatial directions. In a further variant, the spherical base body may support a plurality of flat mirrors, the face normals of the flat mirrors pointing in different spatial directions. These different spatial directions may in turn be distributed evenly, but it is also possible to define preferential directions, so that specific reflectors may for example be used for specific component geometries. Such a reflector with a spherical base body is further preferably rotatable about an axis. In the embodiment with a plurality of flat mirrors fitted to the spherical base body, for example, such a rotation allows for a homogenisation of the reflection in all spatial directions.

In an alternative embodiment, the at least one reflector comprises a flat mirror which is rotatable about at least one axis by means of an adjusting device. Such a mirror is preferably rotatable about three axes in order to reflect incident light in any presettable spatial directions. By means of a control unit which can be connected to the adjusting device, light can be specifically directed on shadow zones of a component without having to change the arrangement or number of reflectors for different components.

Such an exposure chamber is suitable for all commercially available ultraviolet lamps, i.e. low-pressure UV-Iamps, medium-pressure UV-lamps or high-pressure UV-lamps.

The exposure chamber may be designed in different ways. Most commercial designs are conceivable, such as continuous chambers or exposure tunnels as described in WO 2006010301 and DE 102 24 514 A1.

A preferred embodiment for the exposure chamber is an exposure tunnel. The interior of the exposure chamber is designed as a tunnel. The UV-lamps are preferably not distributed over the entire inner surface of the exposure chamber, but rather arranged in an essentially annular or rim configuration over the sides of the exposure chamber in one region only. To expose the component, it has to be passed along this rim or ring of UV-Iamps. Either the component or the rim or ring of UV-lamps may be stationary while the other element is moved. The component and the UV-lamps are arranged such that they can be moved past each other in the exposure chamber.

The rim or ring of UV-lamps may be closed or discontinuous. If the rim of lamps is discontinuous, for example if the floor of the chamber is not fitted with any lamps, it is expedient to rotate the component suitably in the exposure chamber.

A further embodiment provides for a gantry-shaped exposure chamber or a gantry system. This variant is similar to the embodiment of the exposure tunnel. The tunnel is however only long enough for fitting a rim of UV-lamps. The gantry is typically movable and guided past the stationary component.

In such continuous chambers, exposure tunnels or gantry systems, the UV-lamps may be arranged inside or outside the chambers. In the external arrangement, the UV-lamp may be recessed into the wall as a part of the wall or separated from the interior of the chamber by a UV-permeable glass in the wall. The at least one reflector has to be arranged such that it can be irradiated by one or more UV-lamps provided outside the exposure chamber.

Internal and external UV-lamps can of course be expediently combined in any one system or exposure chamber.

In a further variant of the invention, the interior of the exposure chamber is spherical or elliptical and the UV-lamps are spherically distributed over an interior wall of the exposure chamber, so that the light is centrally focussed on the centre or on the longitudinal axis of the exposure chamber.

The exposure chamber is provided for hardening surfaces of vehicle bodies which are coated with UV-paint or for any type of component, wherein UV-lamps are distributed in rows or groups across the entire chamber surface in all interior boundary surfaces, such as walls, ceiling, floor and doors. In this process, the vehicle bodies or components are conveyed into and out of or through the exposure chamber using conveyor technology. Depending on process requirements, the exposure chamber may be charged with inert gas.

In contrast to exposure concepts which place the UV-emitters as close as possible to the surface to be hardened, the UV-emitters of the present invention are placed at a distance from the component. The comparatively larger distance from the component is more than compensated according to the invention by the significantly greater number and the focussed arrangement of the UV-emitters.

In order to focus on the centre or the central region, the interior of the exposure chamber is substantially spherical or elliptic. The spherical or elliptic shape as a rule deviates from the ideal shape and can be matched to the contour of the component. For motor vehicle bodies in particular, which are the preferred components for this process, somewhat flattened spheres or ellipses are formed. Depending on the contour of the component, deviations from the symmetry of the spherical or elliptic shape can suitably be implemented to a greater or lesser degree. In this context, it remains essential that the UV-lamps are focussed on the exterior surfaces of the component which are to be hardened.

As a result of the spherical or “all-round” arrangement combined with suitable reflector technology, the exposure level does not decrease towards the centre of the chamber, which would be the case with single emitters, but it increases concentrically. By distributing the exposure units over the entire chamber, the exposure process is made more uniform and more robust against process fluctuations. In particular, an even and uniform exposure of all planes or surfaces of the component is achieved. Such components may be whole vehicle bodies or parts thereof.

A further advantage compared to conventional technologies using individual high-power emitters or non-concentrically focussing arrangements lies in the fact that light yield is very high. The total power of the exposure system which is required for a preset UV-radiation dose is only a fraction of that required in prior art using individual emitters or gantries.

The short exposure times or process cycles are a further essential advantage of the exposure chamber according to the invention.

As power is reduced by using low-pressure UV-lamps, in particular as low-pressure UV-lamps have a very high light yield, less or even no cooling is required.

The problem on which the invention is based is further solved by a hardening system for motor vehicle bodies with the features of patent claim 20. Such a hardening system comprises an exposure chamber as described above, a supporting device in the exposure chamber, a feed tower flooded with inert gas and a corresponding discharge tower, a flow bypass for inert gas which connects the two towers, wherein the exposure chamber is continuously supplied with inert gas via an inlet of the feed tower and freed of inert gas via the discharge tower, the inert gas being at least partially directed via the flow bypass from the discharge tower to the feed tower. A hardening system of this type allows for an optimum integration of the exposure chamber according to the invention into the production line.

The invention and its embodiments are explained in greater detail below with reference to the drawing. Of the drawing:

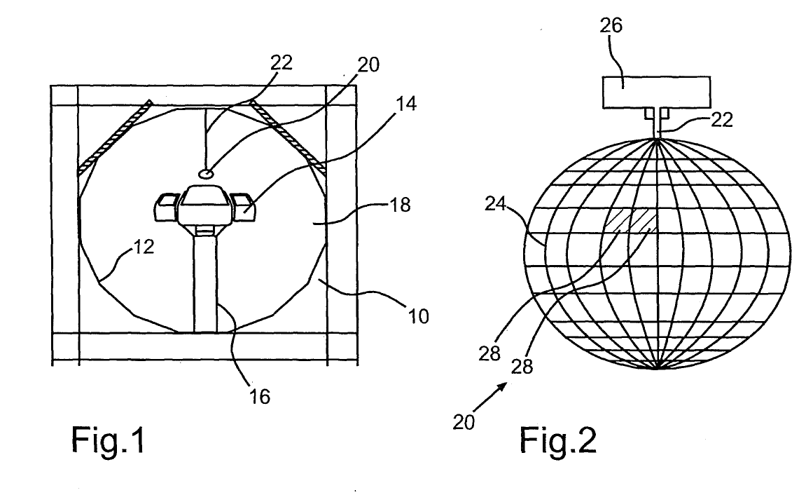

FIG. 1 is a diagrammatic representation of an exposure chamber according to the invention,

FIG. 2 is a diagrammatic representation of a spherical reflector for an exposure chamber according to the invention,

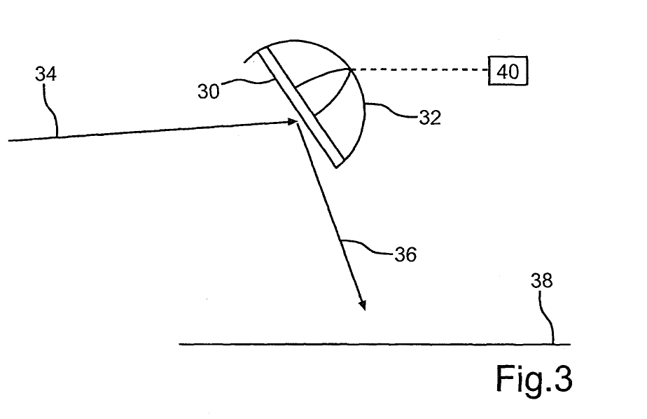

FIG. 3 is a diagrammatic representation of an alternative selectable reflector for an exposure chamber according to the invention,

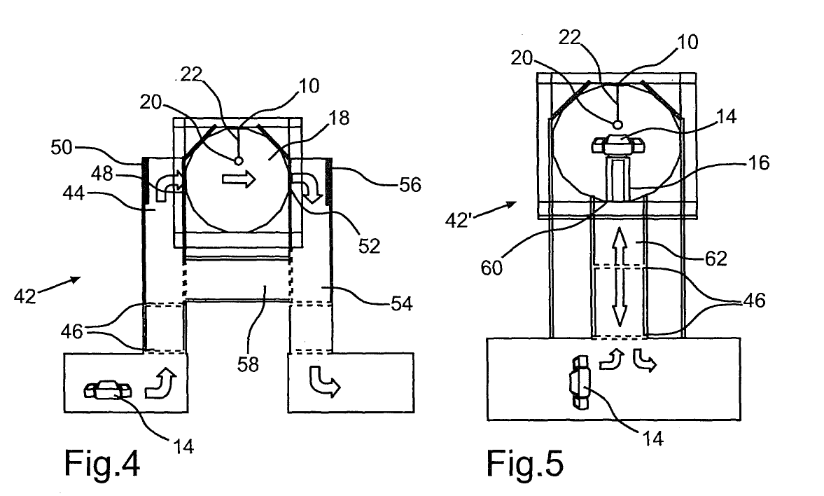

FIGS. 4 and 5 show alternative embodiments of a hardening system according to the invention.

A preferred embodiment of a spherical exposure chamber 10 is illustrated diagrammatically in FIG. 1. The exposure chamber has a diameter of approximately 12 m and accommodates approximately 4200 fluorescent UV-C-tubes. The total light output is set at 500 kW. The lamps are accommodated on the wall 12 in modules which focus the UV-light concentrically on the centre, where the vehicle body 14 is held on the supporting device 16. The illumination intensity can be controlled variably in time during the duration of a process cycle. In this context, specially adapted process characteristics can be adjusted. The UV-lamps are only switched on for the duration of the exposure. In this embodiment, an exposure cycle lies in the range between 2 and 8 seconds.

In an interior 18 of the exposure chamber 10, the invention provides a reflector 20 which is mounted for rotation about an axis 22 and has a spherical base body to direct the light of the UV-lamps mounted on the wall 12 of the exposure chamber 10 onto shade zones of the vehicle body 14. It may in particular be advantageous to install such a reflector 20 into an invisible interior of the vehicle body 14.

FIG. 2 shows such a spherical reflector 20 in detail. It comprises a spherical base body 24 which is joined to the axis 22 and capable of rotating therewith. The axis 22 is connected to a drive unit 26 for automatic rotation. The spherical base body 24 supports a plurality of flat mirrors 28 of which only some are identified for clarity. These flat mirrors may completely cover the spherical base body 24 of the reflector 20, but other arrangements are also possible in order to provide reflection in preferred spatial directions.

The controllable reflector shown in FIG. 3 can be used as an alternative. It comprises a flat mirror 20 mounted in a cardanic suspension 32. By means of a drive unit not shown in the drawing, the mirror 20 can be pivoted about all spatial axes using the cardanic suspension, so that an incident light ray 34 can be directed at any point of a component 38 via a reflected light ray 36. By means of a control unit 40 which determines the position of the mirror 30, different shade zones of the component can be irradiated successively. The exposure chamber 10 can therefore be adapted to different components by simply changing a programme of the control unit 40. If the position of the shadow zones is known, the only action required for an optimal and even exposure of the component is a change to the control programme of the control unit 40.

The UV-lamps used are preferably low-pressure lamps, in particular fluorescent tubes. These are preferably combined to form individual radiation modules of parallel fluorescent tubes. The modules may have different sizes, in particular in terms of the number and length of the fluorescent UV-tubes.

In a further variant, the rear walls of the modules are silvered. The modules or rear walls may be concave or domed to improve the focus on the central region.

In a preferred development, the individual modules are mounted such that they are accessible from the rear or from the outside for replacement. For this purpose, the wall 12 of the exposure chamber 10 may be capable of being dismantled. The lamps on the interior surface may produce a narrow beam, a wide beam or an asymmetric beam as required. Individual modules or reflectors or groups thereof may be movable and have an adjustable emission angle.

The diameter of the exposure chamber 10 and the number of UV-lamps will be chosen such that an illumination intensity of at least 140 kW/cm² is obtained in the central region, which corresponds to the volume of the component 14 or to its external dimensions. The radiation or illumination intensity is preferably set within a range of 20 to 2000 mW/cm². In addition to the packing of the fluorescent tubes or UV-lamps, this value is limited by the diameter of the exposure chamber 10. An uncontrolled increase of the size of the exposure chamber 10 in order to increase luminosity is becoming increasingly uneconomical. In the centre or, in the case of an elliptic design, along the longitudinal axis, illumination intensity is preferably adjusted such that hardening times of less than 30 seconds can be achieved. Luminosity is here preferably set to at least 260 kW/cm².

The spectral distribution of the UV-lamps can be matched to the type of UV-paint used in the process. In particular, it is possible to use fluorescent tubes for a high UV-A, UV-B or UV-C fraction. Owing to the large number of fluorescent tubes, the invention permits a gradual adjustment of the spectrum. Individual fluorescent tubes or entire modules may be used with different UV-spectra in order to set an integral spectral distribution characteristic in a controlled manner.

For an exposure chamber 10 in which motor vehicle bodies 14 are processed, the total power of the UV-lamps will preferably have a value of more than 50 kW, in particular a value in the region between 300 and 750 kW.

The illumination intensity can also be varied in time during the duration of a process cycle. This may be achieved by selecting individual UV-lamps or modules. The power of the system as a whole can be varied as well. This may involve complete disconnection or the reduction of the power of individual units. This constitutes a further advantage of the low-pressure UV-lamps used, because in contrast to systems with high-pressure UV-lamps, it is possible to set highly specific process characteristics or illumination profiles.

The exposure chamber 10 is preferably capable of airtight sealing and operated or flooded with inert gas. The term “inert gas” covers gases or gas mixtures with a reduced inhibitor content for a radical polymerisation of the radiation-curable paints. Such gases include in particular nitrogen, argon or carbon dioxide with an oxygen content of less than 5% by volume.

The quality of radiation-curable coatings is as a rule improved by hardening in an inert gas atmosphere, i.e. by excluding oxygen. This applies in particular to body paints or top coats which are resistant to scratching. Depending on the type of coating, the oxygen content of the inert gas can be adjusted as required. The inert gas may be fed through the exposure chamber either continuously or discontinuously.

Pre-cured or dual-cure paint systems can also be processed. These are usually more tolerant of higher oxygen contents.

In the interior of the exposure chamber 10, a supporting device 16 for the component 14 to be processed is provided. The supporting device 16 orients the component in the centre or along the longitudinal axis of the exposure chamber in order to bring it into the focus of the UV-lamps to the greatest possible extent. The supporting device 16 does not have to be rigid, but it may alternatively be movable. In a movable arrangement, the component 14 can be traversed through the region of maximum focus, or it may be pivoted. In this way, complex component geometries can be illuminated evenly and shadow regions in the interior of a component can be reached.

For receiving the component, in particular a vehicle body 14, the exposure chamber 10 has at least one opening which is preferably closable. By providing a closable opening, the inert gas can be contained within the exposure chamber. In addition, the wall segment occupied by the closable opening can be fitted with UV-lamps.

It may however also be expedient not to provide UV-lamps on the closable opening. The reasons for this are structural in particular. In this case, the respective wall segment should be at least partially transparent in order to allow UV-light to penetrate from the outside.

A further aspect of the invention relates to a hardening system for motor vehicle bodies with radiation-curable coatings.

The hardening system essentially comprises an exposure chamber 10 according to the invention with low-pressure UV-lamps arranged on the interior wall 12 and with closable openings 48, 52, 60 as well as with at least one reflector 20. Conveying towers 44, 54 are provided for the supply of the exposure chamber, in which towers the component 14 is conveyed into the exposure chamber 10, placed on the supporting device 16 and carried away after exposure. Parallel to the exposure chamber 10, a flow bypass 58 for inert gas is provided, which connects the two towers 44, 54 to each other. The flow bypass 58 is used to condition the circulating inert gas, because a large proportion of the inert gas is preferably made to circulate. The gas may be supplied continuously or discontinuously. If required, the exposure chamber 10 and the conveying towers 44, 54 may be separated by flaps 46 to form individual spaces. The flaps 46 are preferably designed for an airtight seal of the gas spaces. This is particularly important if the gas is supplied discontinuously

FIG. 4 shows a possible embodiment of a hardening system according to the invention. The system is constructed such that a vehicle body 14 is introduced into the feed tower 44 from the feeder system from the left. Two flaps 46 provided in the feed tower form a lock for the upper gas space. In this lock the component is flushed with inert gas. The upper flap 46 is then opened, and the component 14 is carried upwards to the exposure chamber 10. Within the upper feed tower 44, an inert gas atmosphere as required for hardening is already provided. Radiators or heaters which are not shown in the drawing may be provided within the feed tower 44, in particular on its walls. In this way, paints having a two-stage hardening mechanism involving thermal and radiation-induced cure can for example be pre- or partially hardened.

The component 14 is then transferred through a first closable opening 48 onto a supporting device in the interior of the exposure chamber 10. In the illustrated variant, this involves a transparent wall segment. In this wall region, the exposure process is ensured by a corresponding exposure unit 50 on the opposite side of the conveying tower.

The conveying tower may accommodate a camera for monitoring the exposure chamber and its equipment, this camera being oriented towards the closable openings.

After exposure the body with its hardened paint is transferred through a further opening 52 into the discharge tower 54, which is likewise provided with an exposure unit 56 corresponding to the opening. The body is then conveyed downwards through the conveying tower, which is still flooded with inert gas, into a lock represented by two flaps and finally discharged.

A flow bypass 58 is provided between the two conveying towers. The flow bypass 58 only has to have the dimensions required for gas circulation. In FIG. 4, the flow bypass 58 is shown enlarged for clearer illustration. The flow bypass 58 is used to balance gas pressure in discontinuous operation and in particular to condition the inert gas returned into the feed tower 44. This involves the separation of oxygen and of any gases which might affect the radiation-curing process. In view of the large volumes of the hardening system, it is advantageous to use recirculated inert gas a far as possible. A high inert gas quality is ensured by a gas scrubbing function of the inert gas conditioning system of the flow bypass 58. Gas scrubbing in particular removes oxygen and water from the gas flow.

A further possible variant of a hardening system is shown in FIG. 5. Here a single conveying tower 62 is used for supplying and discharging the component. The closable opening 60 is fitted with UV-lamps in this case. The supporting device 16 may be structurally combined with the lifting device within the conveying tower. In this embodiment, it is provided with a pivoting mechanism for pivoting the vehicle body 14 from the vertical position in order to move it through the conveying tower 62 to adopt a horizontal position in the exposure chamber. The vehicle body may be pivoted during the exposure process for a further improvement of complete illumination. The supporting device may include further devices for opening, holding open or closing the doors or tailgates of the motor vehicle body.

The exposure chamber 10 once again accommodates a spherical reflector 20 which is rotatable about an axis 22 in order to ensure a uniform illumination of the vehicle body 14. In this embodiment, it is obviously likewise possible to accommodate several such reflectors 20 in the exposure chamber 10 or to use other types of reflectors in order to optimise the uniform illumination of the vehicle body 14.

### LIST OF REFERENCE NUMBERS

10 Exposure chamber
12 Wall
14 Vehicle body
16 Supporting device
18 Interior
20 Reflector
22 Axis
24 Base body
26 Drive unit
28 Mirror
30 Mirror
32 Suspension
34 Light ray
36 Light ray
38 Component
40 Control unit
42, 42′ Hardening system
44 Feed tower
46 Flaps
48 Opening
50 Exposure unit
52 Opening
54 Discharge tower
56 Exposure unit
58 Flow bypass
60 Opening
62 Conveying tower

1.-26. (canceled)

27. An exposure chamber (10) for hardening radiation-curable coatings on components (14) having surfaces which are oriented in different directions, in particular for motor vehicle bodies coated with UV-paints, by means of at least one UV-lamp located directly on or in the wall of the exposure chamber or outside the exposure chamber, wherein in the interior (18) of the exposure chamber, at least one reflector (20) for UV-rays is arranged such that the UV-radiation from the wall region of the exposure chamber or from outside the exposure chamber is reflected by the reflector (20) into a shadow zone of a component (14) which cannot be reached directly by the UV-rays, wherein the reflector (20) can be located within a component (14) or a motor vehicle body which has been coated with UV-paints, and wherein the at least one reflector (20) has a spherical base body (24).

28. The exposure chamber (10) according to claim 27, wherein the spherical base body (24) supports a plurality of flat mirrors (28), the face normals of the flat mirrors pointing in different spatial directions.

29. The exposure chamber (10) according to claim 27, wherein the reflector (20) is pivotable or rotatable about an axis (22).

30. The exposure chamber (10) according to claim 27, wherein the at least one reflector (20) comprises at least one flat mirror (30) which is rotatable about at least one axis by means of an adjusting device.

31. The exposure chamber (10) according to claim 27, wherein the UV-lamps are low-pressure UV-lamps and/or medium-pressure UV-lamps and/or high-pressure UV-lamps.

32. The exposure chamber (10) according to claim 27, wherein the interior (18) of the exposure chamber (10) is substantially spherical or elliptic, and the UV-lamps are spherically arranged over the interior wall (12) of the exposure chamber (10), so that the light is focused concentrically on the centre or the longitudinal axis of the exposure chamber (10).

33. The exposure chamber (10) according to claim 32, wherein the UV-lamps are fluorescent UV-tubes and are arranged in individual radiation modules of parallel-oriented fluorescent tubes.

34. The exposure chamber (10) according to claim 27, wherein the interior (18) of the exposure chamber (10) is tunnel-shaped, and the UV-lamps are arranged substantially in an annular or rim configuration on or in the sides of the exposure chamber, the component or the UV-lamps being movable past each other in the exposure chamber.

35. The exposure chamber (10) according to claim 32, wherein the diameter of the exposure chamber (10) and the number of UV-lamps are adjusted such the radiation density or illumination intensity in the centre or the longitudinal axis of the exposure chamber (10) is at least 140 mW/cm² and/or the radiation density or illumination intensity lies in the range between 200 and 2000 mW/cm².

36. The exposure chamber (10) according to claim 27, wherein the exposure chamber (10) can be closed air-tight and operated with or flooded by inert gas.

37. The exposure chamber (10) according to claim 27, wherein a supporting device (16) for securing a component (14) is provided in the interior of the exposure chamber, so that the component (14) can be oriented in the centre or along the longitudinal axis by the supporting device (16).

38. The exposure chamber (10) according to claim 27, wherein the exposure chamber (10) is provided with at least one closable opening (48, 52) for the accommodation of the component (14), and the closable opening (48, 52) does not support any UV-lamps but is at least partially transparent for penetration of UV-light from the outside.

39. The exposure chamber (10) according to claim 27, wherein the exposure chamber (10) is provided with two opposite openings (48, 52) for the supply and discharge of the component (14), through which openings corresponding UV-lamps (56) can radiate UV-light from the outside.

40. A hardening system (42, 42′) for motor vehicle bodies with radiation-curable coatings, comprising:
an exposure chamber (10) for hardening radiation-curable coatings on components (14) having surfaces which are oriented in different directions, in particular for motor vehicle bodies coated with UV-paints, by means of at least one UV-lamp located directly on or in the wall of the exposure chamber or outside the exposure chamber, wherein in the interior (18) of the exposure chamber, at least one reflector (20) for UV-rays is arranged such that the UV-radiation from the wall region of the exposure chamber or from outside the exposure chamber is reflected by the reflector (20) into a shadow zone of a component (14) which cannot be reached directly by the UV-rays, wherein the reflector (20) can be located within a component (14) or a motor vehicle body which has been coated with UV-paints, and wherein the at least one reflector (20) has a spherical base body (24),
a supporting device (16) in the exposure chamber (10),
a feed tower (44) and a corresponding discharge tower (54) flooded with inert gas,
a flow bypass (58) for inert gas which connects the two conveying towers (44, 54) to each other,
wherein the exposure chamber (10) is in a continuous process continuously supplied with inert gas via an inlet of the feed tower (44) and emptied via the discharge tower (54), the inert gas being at least partially carried via the flow bypass (58) from the discharge tower (54) to the feed tower (44).
